(19) United States
(12) Patent Application Publication
(10) Pub. No.: US 2009/0056209 A1
(43) Pub. Date: Mar. 5, 2009

(54) BIODEGRADABLE AGRICULTURAL FILM

(75) Inventors: Radu Baciu, Langley (CA); Joseph G. Gho, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: EPI ENVIRONMENTAL TECHNOLOGIES (NEVADA) INC., Reno, NV (US)

(21) Appl. No.: 11/846,448

(22) Filed: Aug. 28, 2007

(51) Int. Cl. A01N 3/00; A01G 7/00; B29C 47/12; B32B 27/00

(52) U.S. Cl. 47/9; 264/211.13; 428/500; 504/113

(57) ABSTRACT

A degradable plastic film for use as an agricultural mulch film comprises two longitudinal bands each adjacent to a respective longitudinal edge of the film, and a middle section between the bands. The bands and middle section contain degradants. In use, the bands along the edges of the mulch film are buried in the soil and the middle section is exposed to sunlight. By reason of different degradants in the bands and middle section respectively, or different levels of the same degradants, the entire film degrades by the time of the next cycle of cultivation. The film is produced by means of extrusion from two extruders through one circular die which has a die opening with one segment which receives resin with one degradant and another segment which receives resin with a second degradant. The extruded cylindrical film is blown and then slit longitudinally.

### FIELD OF THE INVENTION

This invention pertains to biodegradable plastic agricultural films and to methods for using and making them.

### BACKGROUND OF THE INVENTION

Plastic films are used for agricultural applications such as mulching, where a mulching film is used to cover the ground at the base of growing plants. The film retains moisture about the roots of the plants, keeps the fertilizers, pesticides etc. close to the plants, inhibits the growth of weeds, and prevents drainage and washing away by rain, wind, etc. Mulching films are typically applied along lengthy rows of seeds or seedlings. For efficient farming, such films must fragment and degrade into the soil at the end of the growing season, and it is known to include additives in the films to bring about such fragmentation and degradation.

In some applications, the edges of the mulching films are buried in the soil in order to anchor and stabilize the films on the ground. This results in a middle section of the film being exposed generally to sunlight and sections along the edges that are not so exposed. This can cause failure of the film to degrade uniformly and leave parts that interfere with the operation of agricultural equipment when the ground is next cultivated.

### SUMMARY OF THE INVENTION

The invention provides an agricultural film that degrades satisfactorily across its entire width despite having a portion that, in use, is not exposed to sunlight (i.e. the buried edges) and a portion that is so exposed (i.e. the middle, unburied portion). The invention further provides a method for making such film.

The invention provides a degradable plastic mulching film comprising two longitudinal bands each adjacent to a respective longitudinal edge of the film, the bands comprising a first degradant, and a middle section between the two bands, the middle section comprising a second degradant. The film is adapted for use with the bands buried in soil and the middle section exposed to ambient light. The first and second degradants and their respective weight percentages are selected such that, in use, both the buried bands and the exposed middle section degrade sufficiently by the time of the next cycle of cultivation that they do not interfere with the operation of agricultural equipment.

The invention further provides a degradable plastic film comprising two longitudinal bands each adjacent to a respective longitudinal edge of the film, the bands comprising a first degradant, and a middle section between the two bands, the middle section comprising a second degradant. The first degradant has a higher level of thermal-activation than the second degradant. The second degradant may also have a higher level of photo-activation than the first degradant.

The invention further provides a degradable plastic film comprising two longitudinal bands each adjacent to a respective longitudinal edge of the film, and a middle section between the two bands, the bands and the middle section containing a degradant. The degradant in the bands and in the middle section may be the same or different. The weight percent of the degradant in the bands is higher than the weight percent of the degradant in the middle section.

The invention also provides a method of making a degradable plastic film using a blown film line. The plastic film comprises two longitudinal bands each adjacent to a respective longitudinal edge of the film, the bands comprising a first degradant, and a middle section between the two bands, the middle section comprising a second degradant. An extrusion die is provided having a circular die opening, the die opening comprising a first part forming one segment of the opening and a second part forming a second and complementary segment of the die opening. Plastic resin comprising the first degradant is delivered from a first extruder to the first segment of the die opening. Plastic resin comprising the second degradant is delivered from a second extruder to the second segment of the die opening. The resins are extruded through the die opening to produce a cylindrical plastic film having a first longitudinally-extending portion comprising the first degradant and a second longitudinally-extending portion comprising the second degradant. The cylindrical film is then expanded by blowing. The expanded cylindrical film is slit longitudinally through the first longitudinally-extending portion to make two longitudinal edges, with a part of the first longitudinally-extending portion adjacent to each respective edge. The same method for making the plastic film is used to make the embodiment of the film in which the same degradant is present in both the middle section and the bands, at different levels. Here, of course, resin containing the degradant at one level is provided to the first extruder and resin containing the same degradant at a second level is provided to the second extruder.

These and other features of the invention will be apparent from the following description and the drawings of the preferred embodiments.

### BRIEF DESCRIPTION OF THE DRAWINGS

FIG. 1 is plan view of a film according to the invention.

FIG. 2 is an end view of the opening of an extrusion die for extruding the cylindrical film.

FIG. 3 is a perspective view of an extruded cylindrical film prior to slitting.

### DESCRIPTION OF THE PREFERRED EMBODIMENTS

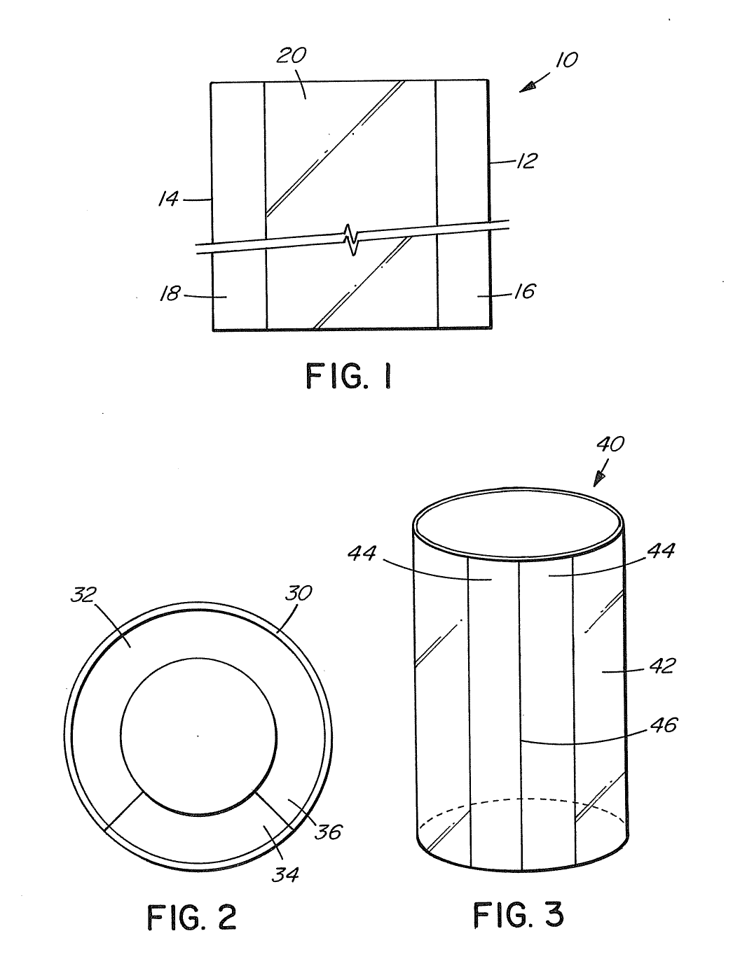

Referring to FIG. 1, the mulching film 10 is an elongated plastic sheet having longitudinal edges 12, 14. The film 10 has two longitudinal bands 16, 18, each adjacent to a respective longitudinal edge 12, 14, and a middle section 20 between the two bands. When the film 10 is used as a mulching film, the bands are the portions of the film that are buried in the soil, and the middle section 20 is the part that is above the ground and exposed to ambient light. The bands 16, 18 are nominally about 20 centimeters wide each and are typically 15 to 30 centimeters wide.

The film 10 is nominally about 7 microns in thickness and about 100 centimeters wide. It can be any thickness and width suitable for a particular agricultural application. Thicknesses from about 5 to 200 microns and widths from about 20 to 600 centimeters are typical.

The film is made by extrusion and blowing of polymer compositions. The polymers that can be used are preferably hydrocarbons that can degrade in an outdoor environment by an oxidative mechanism to give, after complete biodegradation, carbon dioxide, water and biomass. Preferred polymers are saturated polyolefins, for example polyethylene, polypropylene and their copolymers, and polystyrene and its blends. Polyethylene is preferred.

The bands 16, 18 and the middle section 20 all contain one or more degradants. The degradants in the bands and in the middle section may be the same or different. Examples of suitable degradants for both the bands and the middle section are metal carboxylates, including carboxylates containing aluminum, antimony, barium, bismuth, cadmium, cerium, chromium, cobalt, copper, gallium, iron, lanthanum, lead, lithium, magnesium, manganese, mercury, molybdenum, nickel, potassium, rare earths, silver, sodium, strontium, tin, tungsten, vanadium, yttrium, zinc, or zirconium, and combinations thereof. Some preferred metal carboxylates are ferric stearate, iron III stearate, ferric 12-hydroxy-stearate, cobalt stearate, manganese stearate and vanadium stearate. The degradants may also comprise a combination of a metal carboxylate and an aliphatic polyhydroxy-carboxyl acid. For the purpose of this invention, such acid is an aliphatic acid having either more than one hydroxy (—OH) or more than one carboxyl (—COOH) group in the organic acid. The aliphatic polyhydroxy-carboxyl acids are illustrated by the aliphatic, dihydroxy, monocarboxyl acids, such as glyoxylic acid and glyceric acid; the aliphatic, polyhydroxy, monocarboxyl acids, such as erythric acid, arabic acid or mannitic acid; the aliphatic, monohydric, dicarboxyl acids, such as tartronic acid or malic acid; the aliphatic, di-hydroxy, dicarboxyl acids, such as tartaric acid; the aliphatic, polyhydroxy, dicarboxyl acids, such as trihydroxyglutaric acid and succharic acid; and the aliphatic, monohydroxy, tricarboxyl acids, such as citric acid.

In one embodiment of the film, the degradant in the bands has a higher level of thermal-activation than the degradant in the middle section. Preferred degradants for the bands in this embodiment comprise cobalt stearate, manganese stearate, vanadium stearate, and combinations thereof. Optionally, the degradant in the middle section may also have a higher level of photo-activation than the degradant in the bands. Preferred degradants for the middle section comprise ferric stearate, iron III stearate, ferric 12-hydroxy-stearate, and combinations thereof.

In another embodiment of the film, the same degradant, or combination of degradants, is present in both the middle section 20 and the bands 16, 18, but in differing amounts such that, in use in the field, the exposed middle section of the film and the buried bands all degrade sufficiently by the time of the next cycle of cultivation. This is achieved by incorporating a higher proportion of the degradant in the bands than in the middle section.

The amount of degradant incorporated into the resin which comprises the middle section 20 of the film is between 0.01 and 15 weight percent, preferably between 0.05 and 3 weight percent.

The amount of degradant incorporated into the resin comprising the bands 16, 18 is between 0.01 and 15 weight percent, preferably between 0.05 and 3 weight percent.

In use as an agricultural mulching film, both the exposed middle section 20 and the buried bands 16, 18 of the film 10 degrade sufficiently by the time of the next cycle of cultivation that they do not interfere with the operation of agricultural equipment. At that point, the entire film is readily broken into small pieces by plowing and disintegrates into the soil. The time when it is necessary for such degradation to occur after the mulching film is applied to the ground will vary depending on the climate and the crop to be grown. It may be, for example, from a few months to eight months or more, when the field is plowed or worked in preparation for planting the next crop. Accordingly, the film is made to degrade in a time period that is appropriate for a particular agricultural application, by means of selecting the particular degradants and their concentrations in the middle section and bands of the film.

The film 10 may include fillers of the types conventionally used in degradable plastic films. The fillers are preferably readily-degradable polymeric materials, including starch, lignin and cellulose. The fillers may also be inorganic fillers such as calcium carbonates, magnesium carbonate or other inorganic carbonates, nepheline syenite, talc, magnesium hydroxide, aluminum trihydrate, diatomaceous earth, mica, natural or synthetic silica and calcined clays. The amount of filler in the films is preferably between 0.1 and 45 weight percent, more preferably between 1 and 15 weight percent.

The resin mixtures used to make the film 10 may also include additives that are commonly used in making degradable plastic films, including antioxidants, UV stabilizers, processing aids and slip agents.

It will be understood by persons skilled in the art that, in addition to controlling the degradation rate and total degradation time of the film, it is desirable to also control the shelf life (time between manufacture and application) and the service life of the film. Therefore, in addition to the metal carboxylate degradants, it is desirable to include antioxidants and UV stabilizers in the film, in order to control the shelf and service life. In the films of the invention, antioxidants are used in the bands. UV stabilizers are not required in the bands because they are not exposed to sunlight. A combination of antioxidants and UV stabilizers is used in the middle section, as it is exposed to both sunlight and heat. Antioxidants are typically present at some level in the plastic resin as supplied by resin manufacturers, and additional antioxidant and the UV stabilizer are added when compounding the mixtures of resin and degradants for making the bands and middle section of the film. The type and concentrations of antioxidant and UV stabilizer are selected to produce the film shelf life and service life appropriate for a particular application.

The film 10 is an integral, one-piece product comprising a single layer. However, the invention includes films having two or more layers co-extruded together. For example, two or more layers may be used to achieve a film having specific mechanical, optical, chemical or physical properties. Co-extrusion to achieve desired properties is well known in the art. In the present invention, multi-layer films have the middle section 20 and the bands 16, 18 with the degradant properties as described above for single layer films, the degradants being present in each layer.

The film 10 is made using a blown film line having an extrusion apparatus which has two extruders, each with its own hopper, controller, and motor and gearbox. The two extruders feed to a single, circular extrusion die. The circular die 30, shown in FIG. 2, has an opening 32 comprising two segments 34, 36. Each segment 34, 36 receives resin from a respective extruder. The apparatus includes a take-up frame and a winding station equipped with a knife to slit and open the cylindrical film. It includes conventional apparatus for blowing the cylindrical film. The film 10 is made by the following method. A first mixture of resin and a first degradant, and a second mixture of resin and a second degradant, are prepared. The mixtures include fillers and other additives as described above. Dyes may be included to color one of the mixtures, or to color the two mixtures differently, so that the bands of the film are a different color from the middle section. The first mixture of resin, containing the first degradant, is fed to one hopper of the apparatus, and the second mixture of resin, containing the second degradant, is provided to the other hopper. (Alternatively, the components can be fed separately to the extruders where the apparatus is equipped with a multi-hopper system and a computer-controlled gravimetric dosage system; in such case, pre-blending of the components is not required.) The two extruders are operated to extrude the resin mixtures through the extrusion die, the first mixture being extruded through the first segment 34 of the die opening and the second mixture being extruded through the second segment 36 of the die. This forms an extruded, cylindrical film 40 having one longitudinal portion formed from the first segment of the die opening and a second longitudinal portion formed from the second segment of the die opening. The cylindrical film is then blown to the desired size of diameter.

The blown, expanded cylinder of film 40 is shown in FIG. 3. The resin of the second mixture forms a longitudinal portion 42 of the cylinder, and the resin of the first mixture forms another longitudinal portion 44 of the cylinder. The cylindrical film 40 is then slit longitudinally (i.e. in the machine direction) as indicated by cut line 46 in the center of the longitudinal portion 44, forming the film 10 of FIG. 1. It will be apparent that the areas of the longitudinal portion 44 on each side of the cut line 46 of the cylinder form the respective bands 16, 18 of the film 10; and the longitudinal portion 42 of the cylinder 40 forms the middle section 20 of the film 10.

### EXAMPLE 1

A first mixture was prepared having the following composition:

| Component | | Weight Percent |
|---|---|---|
| Polyethylene (LDPE¹) | | 87.75 |
| Cobalt Stearate | | 2.2 |
| Calcium Carbonate | | 10.0 |
| Antioxidant² | | 0.05 |
| | Total | 100.0 |

¹MFI (melt flow index) = 1 g/10 min.
²Irganox 1076 (trademark)

A second mixture was prepared having the following composition:

| Component | | Weight Percent |
|---|---|---|
| Polyethylene (LLDPE¹) | | 48.45 |
| Polyethylene (LDPE²) | | 48.45 |
| Ferric stearate | | 0.8 |
| Talc | | 2.0 |
| Antioxidant³ | | 0.1 |
| UV Stabilizer⁴ | | 0.2 |
| | Total | 100.0 |

¹MFI (melt flow index) = 0.5 g/10 min.
²MFI = 0.8 g/10 minutes
³Irganox 1076 (trademark)
⁴Chimassorb 944 (trademark)

The film was made using an SJ60-2 HDPE/LDPE double-color striped film blown machine made by Ruian Fangtai Printing & Packaging Machinery Co., Ltd., of Ruian City, Zhejiang, China. The machine has two extruders, each with its own hopper, which feed to a single, circular extrusion die. The diameter of the two-piece extrusion die was 60 mm. The inflation die diameter was 350 mm. The temperatures of the seven zones of each extruder were between 170 and 220 degrees C. The temperature of the extrusion die was 210 degrees C. The first resin mixture was extruded by one extruder and the second resin mixture by the second extruder, to produce a cylindrical film having a longitudinally-extending portion comprising the first mixture and a second longitudinally-extending portion comprising the second mixture. The cylindrical film was blown to a diameter of 350 mm and was cut in the middle of the first longitudinally-extending portion. The width of the slit film was 101 cm, the middle portion being 81 cm wide and each of the bands being 10 cm wide. The film thickness was 22 microns. The minimum tensile elongation of the film was 400%.

### EXAMPLE 2

The film of Example 1 was evaluated by conducting accelerated weathering testing of the middle portion of the film and accelerated aging of the bands of the film. The accelerated weathering was done in a QUVse (trademark) cabinet made by Q-Panel Company. The exposure cycle was conducted in accordance with ASTM standard D5208-01 to simulate exposure to ultraviolet light during the day/night cycle. Tensile elongation at break was measured at different time periods in accordance with ASTM D882 and ASTM D3826 to respectively monitor the degradation process and determine the degradation endpoint. The bands were tested by subjecting them to accelerated aging in an oven, with heat exposure only, in accordance with ASTM D5510-01, at temperatures of 50, 60 and 70 degrees C. It was determined from the measured time periods of the test, namely for exposure to ultraviolet light and exposure to heat, that degradation of the middle section and of the buried bands when the film is exposed in actual outdoor conditions in a mulch film application will occur in about the same period of time.

Although the invention has been described in terms of various embodiments, it is not intended that the invention be limited to these embodiments. Various modifications within the scope of the invention will be apparent to those skilled in the art. The scope of the invention is described by the claims that follow.

What is claimed is:

1. A degradable plastic mulching film comprising:
two longitudinal bands each adjacent to a respective longitudinal edge of the film, the bands comprising a first degradant;
a middle section between the two bands, the middle section comprising a second degradant;
the film being adapted for use with the bands buried in soil and the middle section exposed to ambient light, the first and second degradants and their respective weight percentages being selected such that, in use, both the buried bands and the exposed middle section degrade sufficiently by the time of a further cycle of cultivation that they do not interfere with the operation of agricultural equipment.

2. A film according to claim 1 wherein the first degradant has a higher level of thermal-activation than the second degradant.

3. A film according to claim 2 wherein the second degradant has a higher level of photo-activation than the first degradant.

4. A film according to claim 1 wherein the first and second degradants have the same chemical composition and different respective weight percentages.

5. A film according to claim 4 wherein the weight percent of the first degradant is higher than the weight percent of the second degradant.

6. A film according to claim 1 wherein the film comprises one or more coextruded layers and the first and second degradants are both present together within at least one of the layers.

7. A degradable plastic film comprising:
two longitudinal bands each adjacent to a respective longitudinal edge of the film, the bands comprising a first degradant;
a middle section between the two bands, the middle section comprising a second degradant;
the first degradant having a higher level of thermal-activation than the second degradant.

8. A film according to claim 7 wherein the second degradant has a higher level of photo-activation than the first degradant.

9. A degradable plastic film comprising two longitudinal bands each adjacent to a respective longitudinal edge of the film, and a middle section between the two bands, the bands and the middle section containing a degradant, the weight percent of the degradant in the bands being higher than the weight percent of the degradant in the middle section.

10. A film according to claim 1, wherein the plastic is a polyolefin or a polystyrene.

11. A film according to claim 1, wherein the plastic is a polyethylene.

12. A film according to claim 1, wherein the first degradant is a metal carboxylate.

13. A film according to claim 1 wherein the first degradant or the second degradant comprises a combination of a metal carboxylate and an aliphatic polyhydroxy-carboxylic acid.

14. A film according to claim 12 wherein the metal carboxylate is one or more of cobalt stearate, manganese stearate, vanadium stearate, and combinations thereof.

15. A film according to claim 1, wherein the first degradant is present in the bands in the range of 0.01 to 15 weight percent.

16. A film according to claim 1, wherein the second degradant is a metal carboxylate.

17. A film according to claim 16 wherein the metal carboxylate is one or more of ferric stearate, iron III stearate, ferric 12-hydroxy-stearate, and combinations thereof.

18. A film according to claim 1, wherein the first degradant and the second degradant are one or more of carboxylates containing aluminum, antimony, barium, bismuth, cadmium, cerium, chromium, cobalt, copper, gallium, iron, lanthanum, lead, lithium, magnesium, manganese, mercury, molybdenum, nickel, potassium, rare earths, silver, sodium, strontium, tin, tungsten, vanadium, yttrium, zinc, or zirconium, or one or more of ferric stearate, iron III stearate, ferric 12-hydroxy-stearate, cobalt stearate, manganese stearate, vanadium stearate, and combinations thereof.

19. A film according to claim 1, wherein the second degradant is present in the middle section in the range of 0.01 to 15 weight percent.

20. A film according to claim 1, further comprising one or more of a filler, UV stabilizer, antioxidant, processing aid or slip agent.

21. A film according to claim 1 wherein the bands further comprise an antioxidant and the middle section further comprises an antioxidant and UV stabilizer.

22. A film according to claim 20, wherein the filler is one of starch, lignin and cellulose.

23. A film according to claim 20, wherein the filler is an inorganic filler.

24. A film according to claim 23, wherein the inorganic filler is one or more of calcium carbonate, magnesium carbonate, nepheline syenite, talc, magnesium hydroxide, aluminum trihydrate, diatomaceous earth, mica, natural silica, synthetic silica and calcined clays.

25. A method of making a degradable plastic film which comprises two longitudinal bands each adjacent to a respective longitudinal edge of the film, the bands comprising a first degradant, and a middle section between the two bands, the middle section comprising a second degradant, the method comprising the steps of:
(a) providing an extrusion die having a circular die opening, the die opening comprising a first segment and a second segment;
(b) delivering plastic resin comprising the first degradant from a first extruder to the first segment of the die opening;
(c) delivering plastic resin comprising the second degradant from a second extruder to the second segment of the die opening;
(d) extruding the plastic resins through the die opening to produce a cylindrical plastic film having a first longitudinally-extending portion comprising the first degradant and a second longitudinally-extending portion comprising the second degradant;
(e) blowing the cylindrical film to expand it; and
(f) slitting the expanded cylindrical film longitudinally through the first longitudinally-extending portion to make two longitudinal edges, with a part of the first longitudinally-extending portion adjacent to each respective edge.

26. A method according to claim 25, wherein the first degradant has a higher level of thermal-activation than the second degradant and the second degradant has a higher level of photo-activation than the first degradant.

27. A method according to claim 25, wherein the plastic material is a polyolefin or a polystyrene.

28. A method according to claim 25, wherein the plastic material is a polyethylene.

29. A method according to claim 25, wherein the first degradant is a metal carboxylate.

30. A method according to claim 29, wherein the metal carboxylate is one or more of cobalt stearate, manganese stearate, vanadium stearate, and combinations thereof.

31. A method according to claim 25, wherein the first degradant is present in the bands in the range of 0.01 to 15 weight percent.

32. A method according to claim 22, wherein the second degradant is a metal carboxylate.

33. A method according to claim 32, wherein the metal carboxylate is one or more of ferric stearate, iron III stearate, ferric 12-hydroxy-stearate, and combinations thereof.

34. A method according to claim 25, wherein the second degradant is present in the middle section in the range of 0.01 to 15 weight percent.

35. A method according to claim 25, wherein the film further comprises one or more of a filler, UV stabilizer, antioxidant, processing aid or slip agent.

36. A method according to claim 30, wherein the filler is one of starch, lignin and cellulose.

37. A method according to claim 30, wherein the filler is an inorganic filler.

38. A method of making a degradable plastic mulching film which comprises two longitudinal bands each adjacent to a respective longitudinal edge of the film, the bands comprising a first degradant, and a middle section between the two bands, the middle section comprising a second degradant, the film being adapted for use with the bands buried in soil and the middle section exposed to ambient light, the first and second degradants and their respective weight percentages being selected such that, in use, both the buried bands and the exposed middle section degrade sufficiently by the time of a further cycle of cultivation that they do not interfere with the operation of agricultural equipment, the method comprising the steps of:
(a) providing an extrusion die having a circular die opening, the die opening comprising a first segment and a second segment;
(b) delivering plastic resin comprising the first degradant from a first extruder to the first segment of the die opening;
(c) delivering plastic resin comprising the second degradant from a second extruder to the second segment of the die opening;
(d) extruding the plastic resins through the die opening to produce a cylindrical plastic film having a first longitudinally-extending portion comprising the first degradant and a second longitudinally-extending portion comprising the second degradant;
(e) blowing the cylindrical film to expand it; and
(f) slitting the expanded cylindrical film longitudinally through the first longitudinally-extending portion to make two longitudinal edges, with a part of the first longitudinally-extending portion adjacent to each respective edge.

39. A method of using the mulching film of claim 1 in the cultivation of plants, comprising the steps of:
(a) placing the film on the ground; and
(b) anchoring the film by covering the bands with soil while leaving the middle section exposed to ambient light.
